(19) United States
(12) Patent Application Publication
(10) Pub. No.: US 2004/0045613 A1
(43) Pub. Date: Mar. 11, 2004

(54) Diverter valve

(75) Inventors: Francisco Hinojosa JR., Santa Paula, CA (US); Ruben Lerma, Oxnard, CA (US); Steven Kramer, Camarillo, CA (US)

Correspondence Address: KOPPEL, JACOBS, PATRICK & HEYBL, SUITE 107, 555 ST. CHARLES DRIVE, THOUSAND OAKS, CA, 91360, US

(73) Assignee: WATERWAY PLASTICS, INC.

(21) Appl. No.: 10/236,777

(22) Filed: Sep. 6, 2002

(51) Int. Cl. F16K 11/076

(52) U.S. Cl. 137/625.47

(57) ABSTRACT

A diverter valve is disclosed that includes a cylindrical body having a bottom and lid and a plurality of body openings. A closure member is included within the cylindrical body that is movable to block one of the housing holes. A handle is connected to the closure member, with the handle being external to the cylindrical body. The turning of the handle causes the closure member to move within the body. The handle has a first set of vertical teeth and a spline on the lid has a second set of vertical teeth. The first and second sets of vertical teeth engage to lock the handle in place and disengage to allow the handle to turn. A plurality of label tags can also be included, at least one of which is mounted to the diverter adjacent to one of the body openings to indicate the source or destination of fluid flowing through said openings.

### BACKGROUND OF THE INVENTION

1. Field of the Invention

This invention relates to pools and spas and more particularly to a diverter valve used in pool and spa plumbing.

2. Description of the Related Art

Pools are commonly built with an adjacent spa and the pool and spa plumbing can be arranged so that they share components, such as the water pump, filter, heater, air pump, etc. Under certain circumstances it may be desirable to divert the output of one of these components so that it enters the pool or spa only. For example, when using only the spa it may be desirable to divert the heated output of the water pump to the spa, while preventing the output from entering the pool.

Additional aesthetic features are more commonly being added to pools and spas, such as fountains and waterfalls, which can also be connected to the output of a common water pump. It may be desirable to divert the output of the water pump between these features or to block water to both.

Spas can also be arranged with different “banks” of jets or inlets that separately provide a certain massaging effect, and together provide a different massaging effect. The different banks can be attached to the same water pump and it may be desirable to switch between the different banks or to have both the banks operating. It may also be desirable to have none of the banks operating to provide no massaging effect.

U.S. Pat. No. 4,470,429 to Johnson, discloses a three-way rotary plug valve that can be used to block the flow in two of its three passageways. The valve includes an internal valve closure member that is turned by an external lever arm. When the lever arm is positioned in alignment with one of the two passageways, the flow through the passageway is blocked while the flow in the remaining passageway is unobstructed. The valve closure member can also be positioned so that the flow through the two passageways is unobstructed. Once the lever arm is in the desired position, a knob is threaded into an internally threaded sleeve to lock the lever in its position.

One disadvantage of the Johnson plug valve is that the position of the closure member cannot be changed quickly and easily. The knob must be loosened from the threaded sleeve before the handle is turned and tightened again after it is turned. This can be difficult, particularly if the valve is located in a hard to reach location. If the knob is accidentally turned too far out of the threaded sleeve the knob's threads will fully disengage from the threaded sleeve and the knob can be dropped and lost. Also, if the knob is not tightened enough the lever arm is free to move if bumped.

Another disadvantage of this plug valve is that there are no indicators showing the type of device that is coupled to each of the passageways to show which device is being blocked depending on the position of the lever arm. For instance, there are no indicators showing whether a particular passageway is an inlet to the plug valve or an outlet to a pool or spa.

### SUMMARY OF THE INVENTION

The present invention seeks to provide a diverter valve where the closing member can be quickly and easily moved to block one of the diverter's passageways. The invention also seeks to provide a means for easily identifying what type of device is coupled to each of the passageways.

One embodiment of a diverter valve according to the present invention includes a cylindrical body having a bottom and lid, with the cylindrical body having a plurality of body openings. A closure member is included within the cylindrical body that is movable to block one of the housing holes. A handle is connected to the closure member, with the handle being external to the cylindrical body. The turning of the handle causes the closure member to move within the body. The handle has a first set of vertical teeth and a spline on the body's lid has a second set of vertical teeth. The first and second sets of vertical teeth engage to lock the handle in place and disengage to allow the handle to turn.

Another diverter according to the present invention includes the same cylindrical body, body opening and closure member with a handle, but also includes a plurality of label tags. At least one of the tags is mounted to the diverter adjacent to one of the body openings to indicate the source or destination of fluid flowing through the openings.

A pool system according to the present invention is also disclosed that includes a reservoir of water and a plurality of system devices external to said reservoir of water. The system devices accept water from and return water to said reservoir of water, with the system devices conditioning the water. A plumbing system is included that provides a plurality of conduits for circulating water between the reservoir of water and the system devices. One or more diverter valves are also included within the plumbing system to divert water carried by the plurality of conduits.

These and further features and advantages of the invention will be apparent to those skilled in the art from the following detailed description, taken together with the accompanying drawings, in which:

### BRIEF DESCRIPTION OF THE DRAWINGS

FIG. 1 is a perspective view of one embodiment of a diverter valve according to the present invention;

FIG. 2 is a sectional view of the diverter valve shown in FIG. 1;

FIG. 3 is an exploded view of the diverter valve shown in FIG. 1; and

FIG. 4 is a perspective view of a pool and spa using a diverter valve according to the present invention.

### DETAILED DESCRIPTION OF THE INVENTION

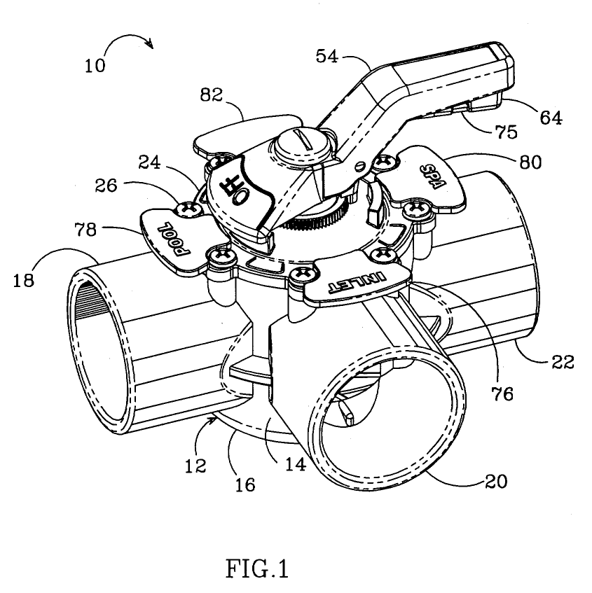

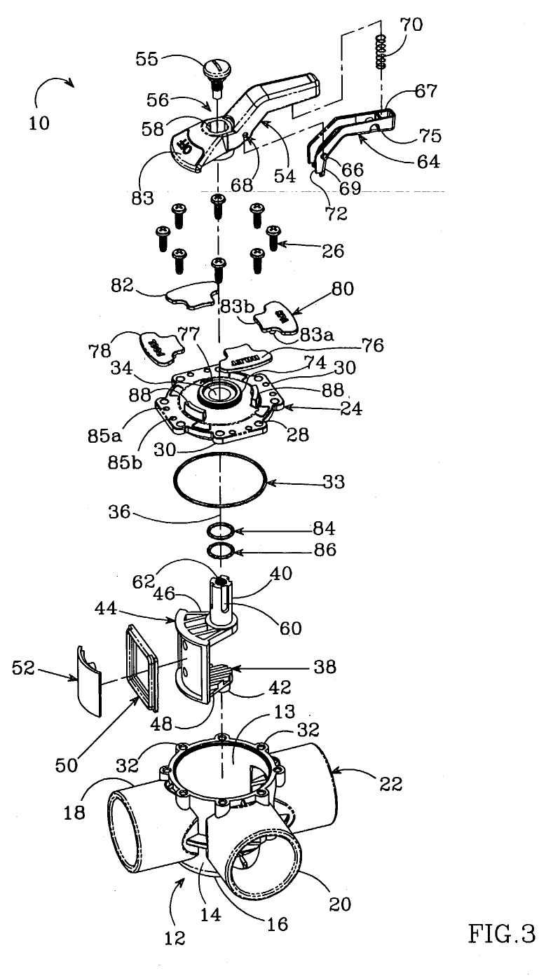

FIGS. 1-3 show one embodiment of a diverter valve 10 according to the present invention. Most of its components are formed from a water impervious plastic such as CPVC, PVC, or ABS. It is particularly adapted to be integrated with the plumbing system of a pool, spa, hot tub, waterfall, and the like, and their related devices such as waterfalls, fountains, skimmers, cleaners, pumps, filters, and the like. The diverter valve 10 is considered a three-way valve because it has three passageways 18, 19, 20. However, diverter valves according to the invention can have two passageways or four or more passageways.

The diverter 10 includes a diverter body 12 having a vertically oriented cylindrical housing 14. A circular bottom section 16 is mounted to the circular bottom opening in the housing 14 with a watertight seal between the two. The body 12 also includes three cylindrical passageways 18, 19, 20, that extend horizontally from the housing's cylindrical surface. Substantially rectangular holes 21, 22, 23, in the housing 14 are aligned with the passageways 18, 19, 20, so that each passageway provides a water inlet or outlet to or from the interior of the housing 14. Each passageway 18, 19, 20, includes a transition section adjacent to the housing so that each passageway can transition from its respective rectangular opening 21, 22, 23, to the cylindrical shape of the passageways. Each passageway 18, 19, 20, is arranged so that it can be connected to the pool or spa's plumbing system, which circulates water between the pool or spa and system's heater, pump, filter, or related device. In one embodiment, each passageway 18, 19, 20, can be coupled to the conduits of a plumbing system, with a respective conduit being mounted within one of the passageways by gluing, although other mounting methods can be used.

A generally circular housing lid 24 is mounted on the top opening of the housing 14 by mounting screws, although many other methods can be used including, but not limited to, pins, clips or adhesives. Eight housing holes 32a-32h are included around the outside surface of the body 14 adjacent to the housing's top opening 13, with two of the eight holes arranged over each one of the passageways 18, 20, 22. For instance, holes 32b, 32c are arranged over the middle passageway 20. The two housing holes 32g, 32h are not over one of the passageways are arranged opposite the holes 32b, 32c.

The housing lid 24 also includes four tabs 30a-30d that are positioned around the circumference of the housing lid 14, with each of the tabs 30a-30d having tab holes 28a and 28b. Each set of tab holes 28a, 28b align with a respective pair of housing holes 32a-32h. Each of the housing holes 32a-32h has threads to mate with the threads on the mounting screws 26. The screws 26 pass through the lid holes 28a, 28b in each of the lid tabs 30a-30d and turn into the housing holes 32a 32h. The lid tabs 30a-30d are sandwiched between the heads of the screws 26 and top surface of the housing holes 32 so that the lid is held securely on the housing's top opening. A lid O-ring 33 is included between the lid 24 and the edge of the housing's top opening to provide a watertight seal between the housing 14 and the lid 24.

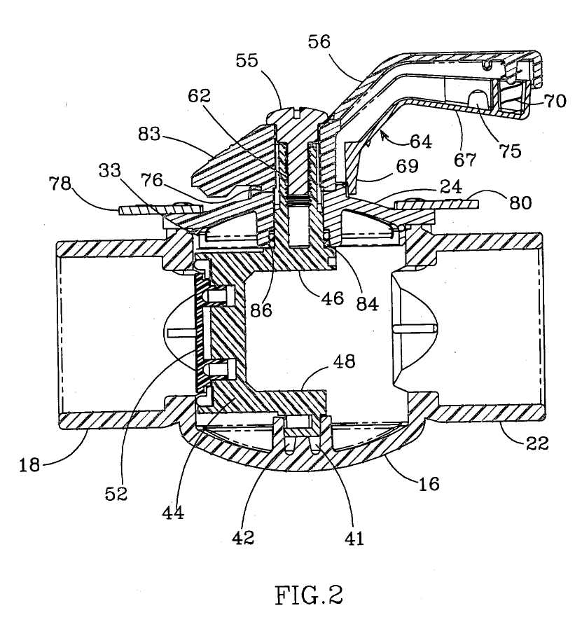

The lid 24 has a central lid hole 34 that is aligned with the housing's longitudinal axis 36. A central bottom hole 41 (shown in FIG. 2) is also included in, but not through, the inner surface of the bottom section 16. The bottom hole is also aligned with the housing's longitudinal axis 36.

A diverter 38 is arranged within the housing 14, between the bottom surface 16 and the lid 24. It has a generally cylindrical rod 40 that passes through the central lid hole 34 and it also has a cylindrical plug 42 that is positioned within the bottom hole 41. The diverter includes a closure member 44, the top of which is mounted to the rod 40 by an upper arm 46 that extends between the top of the closure member 44 and the bottom of the rod 40. The member 44 is mounted to the plug 42 on its bottom by a lower arm 48 that extends between the bottom of the closure member 44 and the plug 42. When the diverter arm 38 is installed in the housing 14 and the housing lid 24 is mounted on the housing 14, the lid 24 is adjacent to the top arm 46 and the rod 40 extends through the central hole 34.

The closure member 44 is formed in an arc that has substantially the same diameter as the inner surface of the housing 14. A rectangular seal 50 is positioned on the outside surface of the member 44 and is held onto the member by a seal retainer 52. Many different seals can be used with the preferred seal being coated by a material such as Teflon®, so that the seal does not need to be lubricated through use. Alternatively, a seal can be used that requires lubrication, and the diverter valve 10 can include an apparatus to lubricate the valve during use.

When the diverter 38 is mounted in the housing 14, there is a small space between the inner surface of the housing 14 and the retainer 52. However, the seal 50 contacts the inner surface of the housing and provides a watertight seal. As the closing member 44 is rotated around the housing's longitudinal axis 36, it intersects the passageways 18, 19, 20. When the closing mechanism 44 is aligned with one of the substantially rectangular holes 21, 22, 23, water is blocked from passing through the passageway. In that position, the seal 50 provides a watertight seal with the housing's inner surface, around the circumference of the blocked housing opening.

A diverter handle 54 is mounted to the diverter arm 38 and can rotate the diverter 38, which in turn rotates the closing member 44 within the housing 14. The diverter handle 54 has a handle hole 56 that mates with the section of the rod 40 that extends from the lid hole 34. The handle hole 56 has longitudinal tabs 58 that mate with longitudinal slots 60 in the rod 40. The diverter handle 54 is held on the diverter 38 by an assembly screw 55, which has threads that mate with threads in the rod's longitudinal hole 62.

A trigger 64 is mounted to the underside of the handle 54 by pins 66 on the trigger 64 that are inserted in pin holes 68 in the handle 54. The trigger has a first section 67 on one side of the pins 66 and a second section 69 on the other side. The trigger 64 can rock back and forth about the pin and hole connection. A spring 70 is held between the handle 54 and the trigger's first section 67, biasing the trigger's first section 67 away from the handle 54. This in turn biases the second section 69 toward the diverter's longitudinal axis 36.

The handle 54 is normally locked in its position by the mating of opposing teeth. The second section 69 has a row of first vertical teeth 72 along its lower edge. A circular spline 76 is arranged around the central hole 34 and has a row of second vertical teeth 74 that mate with the trigger's first teeth 72. When the spring 70 biases the first section 67 of the trigger 64 away from the handle 54, the first teeth 72 are biased against and engage the spline teeth 74, so that the handle 54 cannot be rotated. To rotate the handle, the trigger's first section 76 is compressed toward the handle 54, compressing the spring between the handle 54 and the trigger 64. In response to this action, the trigger teeth 72 are disengaged from the spline teeth 74, freeing the handle to be rotated.

The trigger 64 also has a locking hole 75 arranged so that a locking device such as a padlock can be inserted in the hole 75. The padlock blocks the trigger 64 from being compressed within the handle 54, which prevents the trigger teeth 72 from disengaging from the spline teeth 74. The handle 54 cannot be rotated and is effectively locked in its position until the locking device is removed.

The diverter 10 also includes label tags 76, 78, 80, 82, that can include writings on their top surface to indicate the source or destination of the water passing through the passageways 18, 20, 22. In the embodiment shown, an INLET label 76 is mounted above the passageway 20 and indicates that the passageway is connected to a source of water, such as a spa's water pump. POOL label 78 and SPA label 80 show that the passageways 18 and 22 are connected to a pool and spa, respectfully. In the three-passageway embodiment shown, the blank label 82 does not correspond to a passageway, but could include information such as instructions for use of the diverter 10 or company logos. Alternative labels could include but are not limited to the following: SKIMMER, for the pool or spa skimmer; CLEANER, for the pool cleaner; WATERFALL, for a waterfall; FOUNTAIN, for a pool fountain; and WASTE for backwash from the filter.

The labels can be mounted to the diverter 10 in many different ways and in many different locations such as the top of the housing 14, on the passageway 18, 20, 22 or on the screws 26. A preferred mounting location is to the lid tabs 30a-30d. Each of the labels 76, 78, 80, 82 have two vertical pins 83a, 83b that are inserted into two label holes 85a, 85b in the respective tab. This can be done during manufacture of the diverter valve 10, or at the spa when the diverter valve 10 is installed. The tags can be mounted to the each set of label holes 85a, 85b by many different methods such as press fit or screws, with a preferred method being gluing.

If the tags are not mounted until installation of the poop or spa, the diverter valve 10 provides the flexibility to be configured to match the particular pool or spa plumbing system. The diverter handle 54 has an OFF label 83 arranged so that when the closure member 44 blocks water from passing through a particular passageway, the OFF label is aligned adjacent to the blocked passageway's label 76, 78, 80, 82. Rod O-rings 84, 86 are included to provide a watertight seal between the rod 40 and the lid 24.

In one application of diverter valve 10, passageway 20 is connected to the pool or spa water pump. Blockage of the passageway 20 by the closure member 44 can result in damage to the pump. Accordingly, the lid 24 can have stops 88 to prevent the handle 54 from being turned to block the flow of water through passageway 20.

In operation of one embodiment according to the invention, the diverter valve 10 is connected to the plumbing system of a pool and a spa, or other mechanisms (described above) that utilize the water supplied by a water pump or filter. Water from the pump enters the diverter valve 10 through passageway 20. If the water from the pump is to be supplied to the spa only, the handle 54 is turned until the handle's OFF label 83 aligns with the POOL label 78. The closure member 44 is positioned to block water from entering passageway 18 and all of the water from the pump passes though passageway 22 and into the spa. If the water pump is to be supplied to the pool only, the handle 54 is similarly turned to align the OFF label 83 with the SPA label 80. If water is to be supplied to both the pool and spa, the handle 54 is turned so that the OFF label 83 aligns with label 82. In this position the closure member 44 is positioned so that it is not interfering with water flow through any of the passageways 18, 20, 22.

The diverter valve 10 allows the spa and pool user to control where the pump's water is directed. If the pool is not being used, the pump's water can be blocked from entering it. Conversely, if the spa is not being used the pump's water can be blocked from entering it. A single pump can then be used to supply water a spa, pool, waterfall, etc.

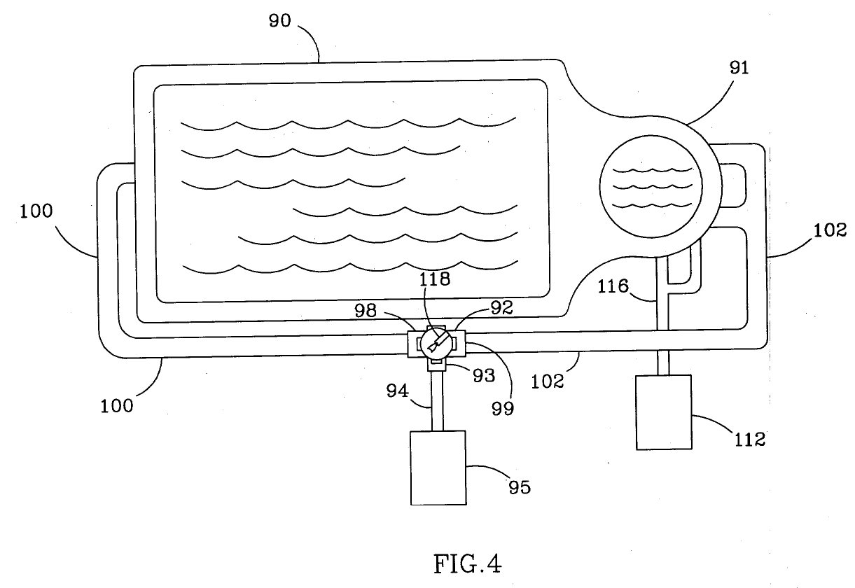

FIG. 4 shows a pool 90 and spa 91, which in combination use a three way diverter valve 92 according to the present invention, although the diverter valve 92 can be used with a pool or spa alone or used with other reservoirs of water. The diverter valve 92 can have different labels mounted around its lid (as described above) and can be coupled to many different pool/spa systems, such as the heater, pump, filter, or related device. In the embodiment shown, the diverter INLET labeled passageway 93 is coupled through conduit 94 to the water pump 95, with the water pump 95 circulating water throughout the pool and spa combination. The POOL labeled passageway 98 is coupled to the pool 90 through conduits 100, and the SPA labeled passageway 102 is coupled to the spa 91 through conduits 102.

An air system 112 can also be included that provides air to the jets in the spa 91, through an air conduit 116 to aerate the water flowing through the jets. The air system 112 can be pump driven to increase the pressure of the air entering the jet, or the system can be vacuum based with the venturi located within the jets drawing air into the jet water streams.

In operation, conduit 94 provides a stream of water to the diverter valve through the INLET passageway 93. The diverter valve 92 can be manipulated by the handle 118 to divert the entering stream of water to the pool 90 or spa 91, or allow the water to pass into both. To divert the water to the pool 90 the handle is turned so that the handle's OFF label is aligned with the SPA labeled passageway 102 and to divert water to the pool, the OFF label is aligned with the POOL labeled passageway 98. To allow water to pass into the pool 90 and spa 91, the OFF label is aligned with the label tag that is positioned on the lid where it is not over a passageway. In this position the internal closure member (described above) is positioned so it is not blocking any of the passageways.

Although the present invention has been described in considerable detail with reference to certain preferred configurations, other versions are possible. The diverter valve could have more or less than three passageways. Other assemblies could be connected to the diverter valve 10, with their corresponding label. Therefore, the spirit and scope of this invention should not be limited to the preferred versions described above.

We claim:

1. A diverter, comprising:
a cylindrical body having a bottom and a lid;
a plurality of body openings through said cylindrical body;
a closure member within said body that is movable to block one of said plurality of housing openings;
a handle connected to said closure member, the majority of said handle being external to said cylindrical body, the turning of said handle causing said closure member to move within said body, said handle having a first set of vertical teeth; and
a spline on said lid having a second set of vertical teeth, said first and second sets of vertical teeth engaging to lock said handle in place and disengaging to allow said handle to turn.

2. The diverter of claim 1, wherein said handle further comprises a trigger, the activation of said trigger causing said first and second sets of vertical teeth to disengage and the releasing of said trigger causing said first and second sets of teeth to engage.

3. The diverter of claim 2, wherein said handle further comprises a spring, the activation of said trigger compressing said spring, said spring urging said trigger to engage said first and second sets of teeth.

4. The diverter of claim 1, wherein said spline is disposed around the longitudinal axis of said body, said second set of vertical teeth directed away from said longitudinal axis and the first set of vertical teeth directed in toward said longitudinal axis.

5. The diverter of claim 1, further comprising a plurality of cylindrical passageways, each of which is mounted to said cylindrical body and aligned with one of said plurality of housing openings, said passageways capable of being connected to pool or spa plumbing.

6. The diverter of claim 1, further comprising a plurality of label tags, at least one of said plurality of tags mounted to said diverter adjacent to at least one of said openings to indicate the source or destination of fluid flowing through said openings.

7. The diverter of claim 6, wherein said plurality of tags are mounted to said lid, at least one of said plurality of tags mounted above at least one of said openings.

8. A diverter, comprising:
a cylindrical body having a bottom section and lid;
a plurality of body openings through said cylindrical body;
a closure member within said body that is movable to block one of said plurality of housing holes;
a handle connected to said closure member, the majority of said handle being external to said cylindrical body, the turning of said handle causing said closure member to move within said body; and
a plurality of label tags, at least one of which is mounted to said diverter adjacent to one of said body openings to indicate the source or destination of fluid flowing through said openings.

9. The diverter of claim 8, wherein said plurality of tabs are mounted to said lid, at least one of said plurality of tabs mounted above one of said plurality of body openings.

10. The diverter of claim 8, further comprising a trigger mounted to said handle, said trigger operable to rotate said handle, said handle being locked in its position when said trigger is not operated.

11. The diverter of claim 10, wherein said trigger has a first set of vertical teeth, said diverter further comprising a spline on said lid having a second set of vertical teeth, said first and second sets of vertical teeth engaging to lock said handle in place and disengaging to allow said handle to turn.

12. The diverter of claim 11, wherein said spline is disposed around the longitudinal axis of said body, said second set of vertical teeth directed away from said longitudinal axis and the first set of vertical teeth directed in toward said longitudinal axis.

13. The diverter of claim 8, further comprising a plurality of cylindrical passageways, each of which is mounted to said cylindrical body and aligned with a one of said plurality of housing openings, said passageways capable of being connected to pool or spa plumbing.

14. A pool system, comprising:
a reservoir of water;
a plurality of system devices external to said reservoir of water that accept water from and return water to said reservoir of water, said system devices conditioning the water in said reservoir of water;
a plumbing system that provides a plurality of conduits for circulating water between said reservoir of water and said system devices;
one or more diverter valves within said plumbing system to divert water carried by said plurality of conduits.

15. The pool system of claim 14, further comprising a second reservoir of water, said plumbing system also circulating water between said second reservoir and said system devices, said one or more diverter valves operable to divert water from said first or second reservoirs of water.

16. The pool system of claim 14, wherein each of said one or more diverter valves comprises:
a cylindrical body having a bottom and a lid;
a plurality of body openings through said cylindrical body;
a closure member within said body that is movable to block one of said plurality of housing openings;
a handle connected to said closure member, the majority of said handle being external to said cylindrical body, the turning of said handle causing said closure member to move within said body, said handle having a first set of vertical teeth; and
a spline on said lid having a second set of vertical teeth, said first and second sets of vertical teeth engaging to lock said handle in place and disengaging to allow said handle to turn.

17. The pool system of claim 16, wherein said handle further comprises a trigger, the activation of said trigger causing said first and second sets of vertical teeth to disengage and the releasing of said trigger causing said first and second sets of teeth to engage.

18. The pool system of claim 17, wherein said handle further comprises a spring, the activation of said trigger compressing said spring, said spring urging said trigger to engage said first and second sets of teeth.

19. The pool system of claim 16, wherein said spline is disposed around the longitudinal axis of said body, said second set of vertical teeth directed away from said longitudinal axis and the first set of vertical teeth directed in toward said longitudinal axis.

20. The pool system of claim 16, further comprising a plurality of cylindrical passageways, each of which is mounted to said cylindrical body and aligned with one of said plurality of housing openings, said passageways capable of being connected to pool or spa plumbing.

21. The pool system of claim 16, further comprising a plurality of label tags, at least one of said plurality of tags mounted to said diverter adjacent to at least one of said openings to indicate the source or destination of fluid flowing through said openings.

22. The pool system of claim 16, wherein said plurality of tags are mounted to said lid, at least one of said plurality of tags mounted above at least one of said openings.

23. A diverter valve, comprises:
a cylindrical body having a bottom and a lid;
a plurality of passageways allowing the flow of water to the interior of said cylindrical body;
a closure member within said body that is movable to block the flow into one of said plurality of passageways;
a handle connected to said closure member, the turning of said handle causing said closure member to move within said body to block the flow in a desired one of said passageways, said handle further comprising a trigger, said handle being turnable when said trigger is activated and locked when said trigger is not activated.
